(19) United States
(12) Patent Application Publication
(10) Pub. No.: US 2010/0015919 A1
(43) Pub. Date: Jan. 21, 2010

(54) METHOD, APPARATUS AND SYSTEM FOR MANAGING MULTI-TYPE SHORT-RANGE WIRELESS COMMUNICATIONS

(75) Inventor: Dan Tian, Beijing (CN)

Correspondence Address: CHALKER FLORES, LLP, 2711 LBJ FRWY, Suite 1036, DALLAS, TX, 75234, US

(73) Assignee: IVT (BEIJING) SOFTWARE TECHNOLOGY INC., Beijing (CN)

(21) Appl. No.: 12/527,066

(22) PCT Filed: Feb. 4, 2008
(86) PCT No.: PCT/CN08/00311

§ 371 Date: Aug. 13, 2009

(30) Foreign Application Priority Data
Feb. 13, 2007 (CN) CN200710063851.0

(51) Int. Cl. H04B 7/00

(52) U.S. Cl. 455/41.2

(57) ABSTRACT

A method, an apparatus and a system for managing multi-type short-range wireless communications for a wireless combination device are provided. The system has one wireless combination device and at least one other wireless device, in which the wireless combination device has multiple wireless communication modules for respectively supporting various type short-range wireless communications, and has one wireless connection management module connected with the wireless communication module and one wireless connection management interface connected with the wireless connection management module in order to manage uniformly multiple different types wireless communications between the wireless combination device and at least one other wireless device. For each of the other wireless devices, one unique entity is used to record it in the wireless combination device. The unique entity may be a parameter set, and includes all the wireless communication types supported by the wireless device and corresponding wireless communication parameters. The wireless combination device manages multiple different types communications with the other wireless devices according to the unique entity.

### FIELD OF THE INVENTION

The present invention relates to wireless communication technology, in particular to a method for multiple wireless radios management of short distance wireless communication, along with related devices and system.

### BACKGROUND OF THE ART

These years, various types of short distance wireless communication technologies, such as Bluetooth, Wi-Fi (Wireless Fidelity), Wibree, Wireless USB, UWB (Ultra Wide Band), and the likes, has been widely used in daily life and work, in order that people would not be annoyed by wires and cables.

Take Bluetooth technology as an instance, a Bluetooth device is identified among other Bluetooth devices via global unique Bluetooth Device Address (i.e. Media Access Control, MAC). Two Bluetooth devices could find each other and establish Bluetooth connections through Bluetooth Device Address. A Bluetooth function of one device could be provided for another Bluetooth device in terms of Bluetooth service. One Bluetooth device could provide multiple Bluetooth services simultaneously. A user may establish a Bluetooth link with choosing some Bluetooth service according to the demand. This kind of Bluetooth link is usually called Profile link, since each Bluetooth service is corresponding to an upper application specification (i.e. Bluetooth Profile) of Bluetooth Stack. For example, In Bluetooth network, a local Bluetooth device finds and utilizes Bluetooth services from remote Bluetooth devices, and also provides its own services to remote devices. This procedure is operated by Service Discovery Protocol (SDP), corresponding to the upper Bluetooth Profile Service Discovery Application Profile (SDAP). SDP defines two categories of device roles: SDP client and SDP server. SDP client is the entity which searches for services, and SDP server is the entity which provides services. There is a service record list in the SDP server, containing services and features of SDP server. When an SDP client sends a SDP requirement, the SDP server returns the service record information in the service record list by SDP response.

Take Wi-Fi technology as another instance. Wi-Fi is an industrial standard of wireless network communication defined by IEEE (IEEE 802.11). Two Wi-Fi devices could communicate with each other in terms of Ad-hoc. This communication could also be served by a Base Station (BS) or an Access Point (AP). A Wi-Fi device is identified among other Wi-Fi devices via global unique Media Access Control (MAC). But unlike Bluetooth technology, Wi-Fi only defines Media Access Control layer (MAC layer) and physical layer, without upper application models. When a Wi-Fi device searches for other Wi-Fi devices within communication range, it firstly searches for the Wi-Fi network identification. Then the Wi-Fi device will apply for joining a certain Wi-Fi network corresponding to the network identification. In this way, the Wi-Fi device joins in a Wi-Fi network and may communicate with other Wi-Fi devices in the network. If two Wi-Fi devices are organized in the form of Ad-hoc network, one device could obtain the related parameters like MAC address of the other device. While if a Wi-Fi device communicates with other devices through an AP, it can only obtain the parameters of the AP, but cannot get the parameters of other devices linked to the AP. Thus, if a Wi-Fi device needs to once again connect with an other Wi-Fi device or AP after recording its MAC address, it may apply for joining in the network corresponding to the network identification, by judging whether the targeted MAC address belongs to the wanted Wi-Fi device or AP.

UWB technology is quite similar with Wi-Fi technology. It has MAC layer and physical layer, but does not define upper applications.

It must be pointed out that, the MAC address of Bluetooth, Wi-Fi, and UWB are the specific device addresses in their respective fields. However as these addresses are all shown identically in the form of hexadecimal digits (e.g. 00-45-53-54-00-00 or 00:45:53:54:00:00), the name of MAC address will uniformly be used in the context of this instruction note.

The short distance wireless communication technologies mentioned above has different advantages and disadvantages in bandwidth, signal quality, power consumption, and etc. For the sake of different requirements and different cases, co-existence of various wireless technologies integrated in one device is becoming a more and more important and potential field. Some existing devices like portable computer have been embedded with several wireless interfaces such as Wi-Fi, Bluetooth, and etc, in order to access to LAN or peripheral equipments. In the following sections, the device which respectively supports multiple wireless interfaces of different wireless communications is uniformly called “multi-wireless device”.

At present time, for instance, the Wi-Fi radio and Bluetooth radio of a Wi-Fi/Bluetooth multi-wireless device is usually driven by their respective drivers, and has respective user interfaces. In Bluetooth applications of this kind of multi-wireless device, the device obtains the MAC address, device name and other information of a Bluetooth device from neighboring environment through its Bluetooth driver, and then execute subsequent Bluetooth operations. On the other hand, in Wi-Fi applications of this kind of multi-wireless device, the device obtains the network identification, MAC address, device name and other information of a Wi-Fi device from neighboring environment through its Wi-Fi driver, and then execute subsequent Wi-Fi operations.

Due to the incompatibility of different short distance wireless communication radios integrated in the same multi-wireless device, when the user want to run applications of different types of multiple wireless radios, different application programs corresponding to each wireless application has to be respectively started and operated. This leads to the complexity of operation mode and the indigestion of operation content. Specially, for instance, when a Wi-Fi/Bluetooth multi-wireless device (Device A) simultaneously establishes the Wi-Fi link and Bluetooth link with another wireless device which supports different types of wireless communications, such as Wi-Fi or Bluetooth (Device B), Device B will be shown as a Bluetooth device on the user interface of Bluetooth driver application program of Device A, at the same time Device B will also be shown as a Wi-Fi device on the user interface of Wi-Fi driver application program of Device A. As a result, two application program interfaces are needed to show a same Device B. Moreover, when the Device B is also a multi-wireless device as Device A, it will be shown in same or different identifications on the two application program interfaces of Device A. Consequently, not only the user operation is unable to be uniform, a same Device B would even be taken for two different devices by some users. This brings much inconvenience to the user operation.

In addition, usually the user manually selects and operates the encryption and authentication information when establishing a short distance wireless communication. For instance, when establishing a Wi-Fi communication, the user has to select and enter the network identification, network password (WEP password or WAP password), encryption algorithm, and etc, while in case of Bluetooth, the personal identification pincode is needed. Thus, the user has to frequently enter the encryption and authentication information when multiple short distance wireless communications are established in a multi-wireless device. This procedure is complicated to the user.

### SUMMARY OF THE INVENTION

Considering all these defects of existing technologies, the technical problem to be solved by the present invention is to provide a method along with device and system for multiple wireless radios management of short distance wireless communication used for multi-wireless devices.

On the one hand, this invention provides a system of multiple wireless radios management of short distance wireless communication used for multi-wireless device. This system includes a multi-wireless device and at least one other wireless device, wherein:

The multi-wireless device includes multiple short distance wireless communication module, used for respectively supporting each type of associated wireless communication, in order to communicate with the other wireless devices. The at least one wireless device may only be integrated one type of short distance wireless communication module, or be integrated with more than one type of short distance wireless communication modules. The multi-wireless device is provided with the wireless connection management module for connecting with each wireless module of the at least one wireless device, and also with the wireless connection management interface which connects to the wireless connection management module, used for uniformly managing the multiple types of short distance communications between the multi-wireless device and the at least one wireless device. The wireless connection management interface of the multi-wireless device is demonstrated as a user interface of application program.

In the multi-wireless device, a unique entity is used for record the at least one wireless device. The unique entity is corresponding to a parameter set in the wireless connection management module, including for instance the types of wireless communications supported by the at least one wireless device, and the wireless parameters required by the management of multiple types of wireless communications, e.g. the MAC address corresponding to each wireless communication, or in the Wi-Fi technology the network identification of the network where the at least one wireless device locates, or etc. At the same time, the unique entity displays each wireless device on the wireless connection management interface using the unique identification, for instance icon, name, or etc. The parameter set of the unique entity may further includes the device name and the unique device identifier corresponding to each type of wireless communication of the at least one wireless device. The unique device identifier is globally unique or locally unique, used for the unique identification of the at least one device.

The multi-wireless device manages the wireless communication with the at least one device according to the parameters in the unique entity of the at least one wireless device, i.e. establishes or releases the first type of wireless communication with the at least one wireless device according to the first wireless parameter of the at least one wireless device (for instance MAC address), and/or establishes or releases the second type of wireless communication with the at least one wireless device according to the second wireless parameter of the at least one wireless device (for instance MAC address).

In this way, the user could select a certain wireless device on a uniform wireless connection management interface through the unique identification (for instance the icon), and process the operation of establishing or releasing the first type or the second type of wireless communication. The wireless connection management modules identifies the control command of each operation from the wireless connection management interface, and implements the operations by identifying the wireless parameters corresponding to the wireless device from the parameter set of the unique entity.

Optimally, the multi-wireless device consults with the at least one wireless device about the authentication parameter of the connection of the second type of wireless communication, through the first type of wireless communication module. In this way, the automatic connection authentication is implemented when the multi-wireless device establishes the second type of wireless communication with the at least one wireless device.

On the other hand, this invention provides a method of multiple wireless radios management of short distance wireless communication used for multi-wireless device, wherein:

The multi-wireless device includes at least the first wireless communication module and the second wireless communication module. It also includes the wireless connection management module and wireless connection management interface, in order to uniformly manage the parameter inquiry and response between the multi-wireless device and the at least one device, i.e. when the multi-wireless device sends parameter inquiry commands through the first wireless communication module and the second wireless communication module, the at least one wireless device responds these parameter inquiry commands sent from the multi-wireless device, and then inform the multi-wireless device of its parameters.

Specially, when a certain wireless device from the at least one wireless device is simultaneously provided with the first communication module and the second communication module, this wireless device could be equipped with a wireless manager used for managing the first wireless communication module and the second wireless communication module, which enumerates and configures the wireless parameters of multiple types of wireless communication, including the types of wireless communication supported the wireless device and the parameters required by the management of each type of wireless communication (such as MAC address, network identification in the Wi-Fi technology, and etc.), also may includes the device name and the unique device identifier corresponding to each type of wireless communication.

The specific steps of this method are shown as follows:
(a) The multi-wireless device obtains the list of the wireless devices which support the first type of wireless communication through the first wireless module.
(b) According to the wireless device list, the multi-wireless device establishes the first type of wireless communication in turn with the listed wireless devices through the first wireless communication module. The wireless connection management module of the multi-wireless device sends the user-defined parameter set inquiry command through the first wireless communication module to at least one wireless device. If the inquired wireless device is provided with the wireless manager, then responds with returning the configured parameter set. If there is no response from the inquired wireless device, then the multi-wireless device further sends various parameter inquiry commands defined by the wireless communication standard of the first type of wireless communication to the wireless device, then the wireless device responds with returning the wireless parameters related to its first type of wireless communication.
(c) The multi-wireless device forms the unique entity which identifies the at least one wireless device according to the wireless parameters returned by the wireless device.

According to the method mentioned above, only through the first wireless communication module the multi-wireless device could obtain and form the parameter set of the unique entity of the at least one wireless device which supports the first type of wireless communication (including simultaneously supporting the first type of wireless communication and the second type of wireless communication), including the wireless communication type supported by the at least one wireless device and the parameters required by the management of various types of wireless communications. If the multi-wireless device still need to obtain and form the parameter set of the unique entity of the at least one wireless device which supports the second type of wireless communication, according to the steps mentioned above, the multi-wireless obtains a list of at least one wireless device which supports the second type of wireless communication (including simultaneously supporting the first type of wireless communication and the second type of wireless communication) through the second communication module, and then sends various parameter inquiry commands of the second type of wireless communication through the second communication module, and obtains the parameters of the second type of wireless communication of the at least one wireless device.

To prevent the repetition of the parameters of the second type of the wireless communication, responded and returned by the wireless device which simultaneously supports the first type of wireless communication and the second type of wireless communication, and to insure that the multi-wireless device records the at least one wireless device only using the unique entity, the multi-wireless device will judge if the MAC address of the at least one wireless device obtained through the second type of wireless communication is contained in the parameter set obtained through the first type of wireless communication. If the MAC address is not contained, the multi-wireless device stores the parameters of the second type of wireless communication obtained through the second wireless communication, and forms the unique entity; otherwise the parameters of the second type of wireless communication are not stored.

The unique entity could identify the at least one wireless device according to the unique device identifier of the at least one wireless device. The specific steps are shown as follows:
(a) The wireless connection management module of the multi-wireless device inquires the parameters of the at least one wireless device which supports the first type of wireless communication through the first wireless communication module. The parameters of the at least one wireless device which supports the first type of wireless communication (including the unique device identifier) returns to the wireless connection management module of the multi-wireless device through the first wireless communication module.
(b) The wireless connection management module of the multi-wireless device inquires the parameters of the at least one wireless device which supports the second type of wireless communication through the second wireless communication module. The parameters of the at least one wireless device which supports the second type of wireless communication (including the unique device identifier) returns to the wireless connection management module of the multi-wireless device through the second wireless communication module.
(c) When the multi-wireless device compares all the unique device identifiers obtained from the first wireless communication module with all the unique device identifiers obtained from the second wireless communication module, and compares a certain unique device identifiers obtained from the first wireless communication module with a certain unique device identifiers obtained from the second wireless communication module, it considers that the two identical unique device identifiers obtained from the first wireless communication module and the second wireless communication module represent for a same wireless device. The connection management module of the multi-wireless device merges all the parameters obtained from the first wireless communication module and the second wireless communication module, including the wireless communication types supported by the at least one wireless device, and the parameters required by the management of each type of wireless communication (such as MAC address, network identification in the Wi-Fi technology, and etc.). Thus the parameter set of the unique entity of the wireless device is formed. The wireless device is displayed as the unique entity identification on the wireless connection management interface (for instance icon, name, or etc.).
(d) For other wireless devices of which the identical device unique identifier are not discovered after the comparison mentioned above, the multi-wireless device respectively forms the parameter sets of the unique entities of them and shows them as the unique entity identifiers according to their respective parameters obtained from the first wireless communication module and the second wireless communication module.

In a preferable embodiment of this invention, the unique device identifier mentioned above is defined as the GUID (Global Unique Identifiers). GUID is an alpha-numeric identifier to indicate the uniqueness of a product. GUID applies a uniform format, consisting of numbers from 0-9 or letters from a-f in the form of hexadecimal digits. For instance, 6F9619FF-8B86-D011-B42D-00C04FC964FF is a valid GUID value.

In another preferable embodiment, the unique device identifier mentioned above is defined as the unique device name, e.g. the combination of GUID and name of friendly device, such as “My Computer. 19270efa-a213-4733-b117-bdeb4b4528a2”. In this unique device name, the name of friendly device is “My Computer”, and the GUID is “19270efa-a213-4733-b171-bdeb4b4528a2”, spaced out with “.”. The device name of the first type of wireless communication and the second type of wireless communication of the at least one wireless device is uniformly configured with the unique device name, and the unique entity is formed based on this unique device name. Optimally, the wireless connection management module could pick up the name of the friendly device from the unique device name, and the at least one wireless device is identified by this name of the friendly device on the wireless connection management interface.

In another preferable embodiment, the unique device identifier mentioned above is defined as globally unique or locally unique MAC address. In this case, the MAC addresses of both the first type of wireless communication and the second type of wireless communication of the at least one wireless device could be configured with the unique MAC address. For instance, when the wireless device which supports multiple types of short distance radios leaves factory, the MAC addresses of various types of wireless communication are all configured with a same MAC address, or configured with a unique MAC address through the wireless connection management module of the at least one wireless device at first, and then the MAC addresses of both the first type of wireless communication and then second type of wireless communication of the at least one wireless device are uniformly modified to this configured MAC address.

It is worth notice that, in the case of configuring the unique device identifier as the unique device name and the case of configuring the unique device identifier as the unique MAC address, if Bluetooth technology is supported between the multi-wireless device and the at least one other wireless device, when the multi-wireless device obtains the Bluetooth wireless parameters of the at least one wireless device, the multi-wireless device needs not establish a connection with the at least one wireless device, and the two devices could inquiry and respond the parameters through lower layer interaction of Bluetooth communication module. For instance, within communication range, the multi-wireless device could find other peripheral wireless devices which are ready for establishing the Bluetooth connection through the “General Inquiry Access Code (GIAC)”. Then the peripheral wireless devices which support Bluetooth respond with returning the “Inquiry-res (inquiry response)” information, which includes Bluetooth MAC address and clock information. The multi-wireless device could also inquire the names of peripheral wireless devices through “LMP_Name_Req (LMP name request)” (the Bluetooth device name is a character string. It could be for instance “My Mobile Phone”, “NOKIA 6210”, or etc. The string length is limited within 248 characters). Then the peripheral wireless devices which support Bluetooth feed back to the multi-wireless device with “LMP_Name_Res (LMP name response)”.

In another preferable embodiment, the first type of wireless communication mentioned above is Bluetooth technology, and the second type of wireless communication mentioned above could be any other short distance wireless communication, such as Wi-Fi technology, UWB technology, or similar wireless technology of present or future. The wireless connection management module of the multi-wireless device and the at least one wireless device provides Bluetooth Service Discovery Application Profile (SDAP), which could uniformly manage the parameter inquiry and response between the multi-wireless device and the at least one wireless device through the first wireless communication module and the second wireless communication module, based on SDP request and SDP response of Bluetooth Service Discovery Protocol (SDP). The wireless parameters of the at least one wireless device includes the wireless communication types supported by the at least one wireless device, and the wireless parameters related to each type of wireless communication, such as MAC address, Wi-FI network identification, and etc. It could further include the device name corresponding to each type of wireless communication. After the multi-wireless device establishes the first type of wireless communication and/or the second type of wireless communication with the at least one wireless device, the multi-wireless device inquires the wireless parameters of the at least one wireless device through the SDP request sent by the SDAP in the wireless connection management module. Then the SDAP in the wireless manager of the at least one device feeds back with SDP response, informing the multi-wireless device of the wireless parameters.

According to this invention, a method used for automatic connection authentication between the multi-wireless device and the at least one wireless device is also provided, i.e. after the multi-wireless device establishes the first type of wireless communication with the at least one wireless device, it consults with the at least one wireless device about the connection authentication parameter of the second type of wireless communication between the multi-wireless device and the at least one wireless device, through the first wireless communication module. This connection authentication parameter has different configuration selections according to the specific type of the second type of wireless communication. For instance, when the second type of wireless communication is Bluetooth, the connection authentication parameter could be Bluetooth PIN, while when the second type of wireless communication is Wi-Fi, the connection authentication parameter could be network password (WEP password or WAP password) and encryption algorithm, and etc. In addition, for the sake of enhancing the safety of communication procedure, the multi-wireless device and the at least one wireless device could encrypt the first type of wireless communication, in order to encrypt the connection authentication parameter of the second type of wireless communication, which is consulted about through the first wireless communication module between the multi-wireless device and the at least one wireless device. After the multi-wireless device and the at least one wireless device agree on the connection authentication parameter of the second type of wireless communication, the multi-wireless device stores this connection authentication parameter to the parameter set of the unique entity of the at least one wireless device, while the at least one wireless device stores could store the connection authentication parameter to the configured parameter in its wireless manager. When multi-wireless device needs to establish the second type of wireless communication with the at least one wireless device, it obtains the MAC address of the second type of wireless communication of the at least one wireless device, and then identifies the connection authentication parameter corresponding to the MAC address of the second type of wireless communication from the parameter set of the unique entity, while the at least one wireless device also picks up the stored authentication parameter of the second type of wireless communication. The multi-wireless device and the at least one wireless device respectively use the authentication parameter of the second type of wireless communication for connection authentication.

Through the method for multiple wireless radios management of short distance wireless communication, along with related device and system mentioned above, the multi-wireless device integrated with multiple short distance wireless communication is able to uniformly manage the connections amongst various different wireless devices in a same application program and user interface. Moreover, a unique entity is used for recording each connected wireless device, which is shown as one device to users. In this way, it is very convenient for users to identify and use the wireless applications of each wireless device. In addition, through the method for automatic consultation and connection authentication between the multi-wireless device and the at least one wireless device, the users are free from the troubles of manual operation. The method not only brings convenience and high efficiency, also insures the safety of wireless communication.

### BRIEF DESCRIPTION OF THE FIGURES

It will be helpful to understand the purpose and advantages of the present invention that the preferable embodiments of the invention are explained in detail by means of drawings, wherein:

FIG. 1 is a structural block diagram illustrating the system used for managing multiple short distance wireless communications.

FIG. 2 provides a message flow chart illustrating how the multi-wireless device records another wireless device with the unique entity according to a preferable embodiment of this invention.

FIG. 3 provides another message flow chart illustrating how the multi-wireless device records another wireless device with the unique entity according to a preferable embodiment of this invention.

FIG. 4 is a structural block diagram illustrating the parameter inquiry and response through Bluetooth SDAP according to a preferable embodiment of this invention.

FIG. 5 is a message flow chart illustrating the steps of the automatic connection authentication between the multi-wireless device and another wireless device according to a preferable embodiment of this invention.

### DETAILED DESCRIPTION OF THE EMBODIMENTS

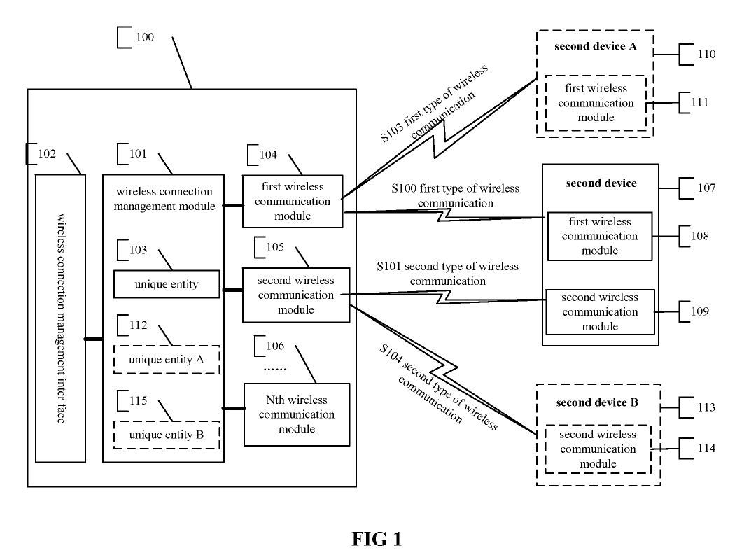

FIG. 1 is a structural block diagram illustrating the system used for managing multiple short distance wireless communications.

As shown in FIG. 1, the system consists of a multi-wireless device and multiple wireless devices. The multi-wireless device is the first device 100, while the multiple wireless devices include the second device 107, the second device A110 and the second device B113. The first device 100 is provided with two or more than two types of short distance wireless communication modules 104, 105, and 106. The first device 100 and the second device 107 are simultaneously provided with two types of short distance wireless communication modules: the first wireless communication module 104 and 108, and the second wireless communication modules 105 and 109, i.e. the first and the type of short distance wireless communication are simultaneously supported. The first device 100 is provided with all supported short distance wireless communication modules, i.e. the first wireless communication module 104, the second wireless communication module 105 till the Nth wireless communication module 106, the wireless connection management module 101 connected with all wireless communication modules, and the wireless connection management interface 102 which is connected with the wireless connection management module and used for uniformly managing the first type of wireless communication S100 and the second type of wireless communication S101 between the first device 100 and the second device 107. The unique entity 103 of the second device 107 is recorded in the wireless connection management module 101 of the first device 100. The unique entity 103 could be a parameter set in the wireless connection management module 101, including various types of wireless communications supported by the second device 107, i.e. the first type of wireless communication and the second type of wireless communication, and related parameters, such as the MAC address of the first type of wireless communication and the second type of wireless communication, and the unique device identifier of the second device 107. The parameter set could further include the device names of the first and the second type of wireless communication of the second device 107. At the same time, on the wireless connection management interface 102, the unique entity 103 acts as displaying the second device 107, the second device A110 and the second device B113 as the unique identifications (for instance icon, name, or etc.). When the unique identification of the second device 107 on the wireless connection management interface 102 is selected and then the related first or second type of wireless communication is operated, the wireless connection management module 101 identifies the signal of this controlling operation, and then obtains associated wireless communication parameters from the parameter set of the unique entity 103, to manage the connection establishment with the first type of wireless communication S100 or the second type of wireless communication S101 of the second device 107. For instance, the wireless connection management module 101 manages the first type of wireless communication S100 with the second device 107 according to the parameters such as the MAC address of the first type of wireless communication in the unique entity 103 of the second device 107, or manages the second type of wireless communication S101 with the second device 107 according to the parameters such as the MAC address of the first type of wireless communication in the unique entity 103 of the second device 107.

The second device A110 is only provided with the first wireless communication module 111. The second device A110 is recorded with the unique entity A112 in the first device 100. The parameter set of the unique entity A112 includes the first type of wireless communication supported by the second device A110, the MAC address of the first type of wireless communication of the second device A110, and etc. When the unique identification of the second device A110 on the wireless connection management interface 102 is selected and then the first type of wireless communication S103 between the first device 100 and the second device A110 is operated, the wireless connection management module 101 obtains the wireless communication parameters such as MAC address of the first type of wireless communication from the parameter set of the unique entity A112 of the second device A110, to manage the first type of wireless communication S103 with the second device A110.

The second device B113 is only provided with the second wireless communication module 114. The second device B113 is recorded with the unique entity B115 in the first device 100. The parameter set of the unique entity B115 includes the second type of wireless communication supported by the second device B113, the MAC address of the second type of wireless communication of the second device B113, and etc. When the unique identification of the second device B113 on the wireless connection management interface 102 is selected and then the second type of wireless communication S104 between the first device 100 and the second device B113 is operated, the wireless connection management module 101 obtains the wireless communication parameters such as MAC address of the second type of wireless communication from the parameter set of the unique entity B115 of the second device B113, to manage the second type of wireless communication S104 with the second device B113.

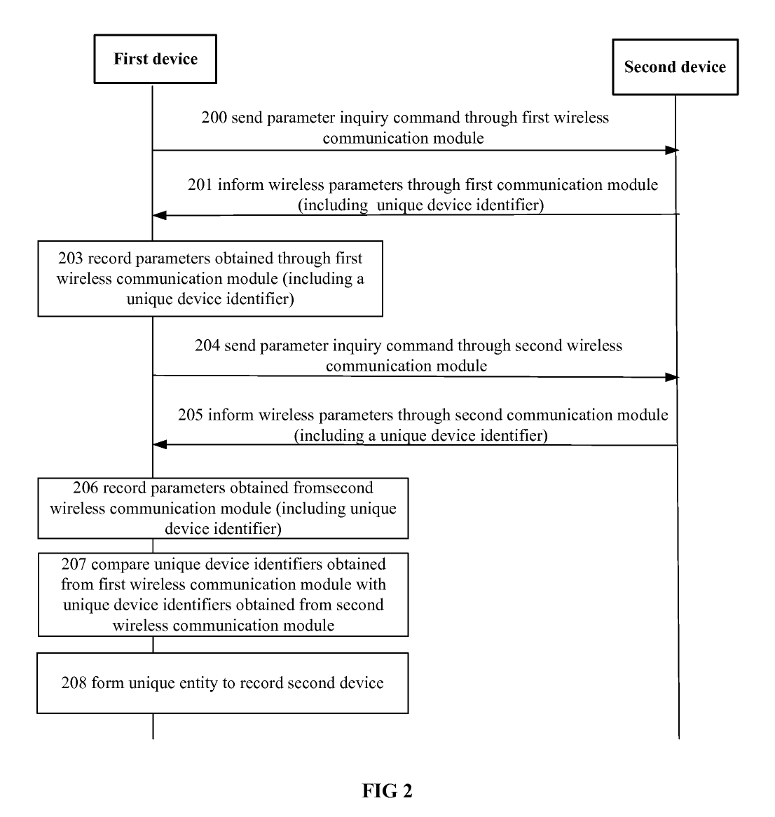

FIG. 2 provides a message flow chart illustrating how the multi-wireless device records another wireless device with the unique entity according to a preferable embodiment of this invention.

Around a multi-wireless device, for instance the first device, there could be multiple wireless devices which support the first type of wireless communication and/or the second type of wireless communication. For the sake of simplification, a second device which simultaneously supports both the first and the second type of wireless communication is taken as an instance for describing the method of this invention.

In this preferable embodiment, both the first device and the second device are simultaneously provided with the first wireless communication module and the second wireless communication module. The first device sends the associated parameter inquiry command 200 related to the first type of wireless communication to the peripheral wireless devices through the first wireless communication module. The second device response to this parameter inquiry command as it supports the first type of wireless communication, and then it informs the first device of the associated parameter 201 (including for instance the MAC address and the unique device identifier of the first type of wireless communication) through its first wireless communication module. Obtained through its first wireless communication module, the first device records the related wireless parameter 202 of the first type of wireless communication of the second device.

Next, the first device sends the associated parameter inquiry command 203 related to the second type of wireless communication to the peripheral wireless devices through the second wireless communication module. The second device response to this parameter inquiry command as it supports the second type of wireless communication, and then it informs the first device of the associated parameter 204 (including for instance the MAC address and the unique device identifier of the second type of wireless communication) through its second wireless communication module. Obtained through its second wireless communication module, the first device records the related wireless parameter 202 of the second type of wireless communication of the second device.

The wireless connection management module of the first device compares all the unique device identifiers obtained from the first wireless communication module with all the unique device identifiers obtained from the second wireless communication module (206). If the wireless connection management module find that a certain unique device identifiers obtained from the first wireless communication module is the same as a certain unique device identifiers obtained from the second wireless communication module, it judges that the two identical unique device identifiers obtained from the first wireless communication module and the second wireless communication module represent for a same wireless device. Here, this could be the case for the second device. Then the second device is recorded with the unique entity in the first device, i.e. according to all the wireless parameters of the second device obtained through the first wireless communication module and the second wireless communication module, the parameter set of the unique entity 207 is formed. This parameter set could include the unique device identifier of the second device and the supported types of wireless communication, i.e. the first type of wireless communication and the second type of wireless communication, and the MAC addresses of the first and the second type of wireless communications. It could further include the wireless parameters such as the device names of the first and the second wireless communication, and etc.

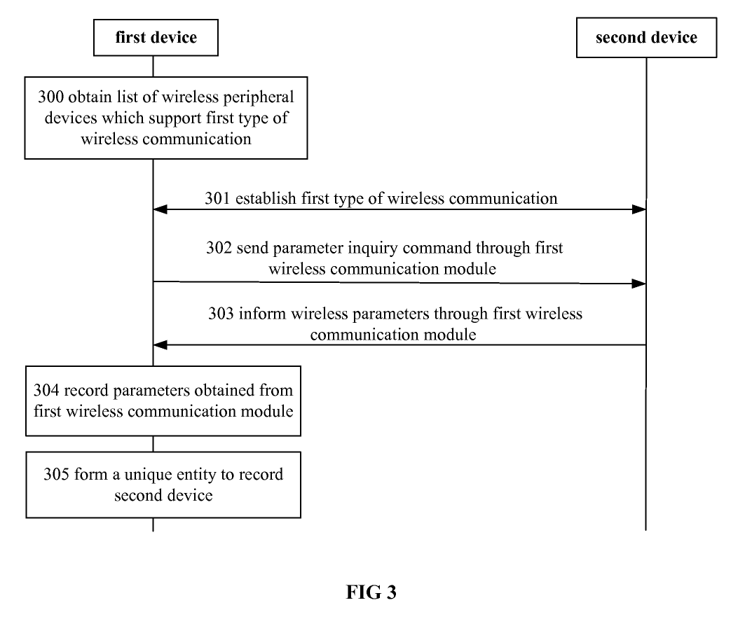

FIG. 3 provides another message flow chart illustrating how the multi-wireless device records another wireless device with the unique entity according to a preferable embodiment of this invention.

Refer to FIG. 1, there could be a second device which simultaneously support the first type of wireless communication and the second type of wireless communication. The second device is provided with wireless manager to enumerate and configure supported types of wireless communications and manage the communication parameters required by each wireless communication, and then forms a parameter set 300 to store the parameters.

The first device inquires devices through the first wireless communication module to obtain the wireless device list 301, of which the peripheral devices support the first type of wireless communication, including the second device. When the first wireless communication module is Bluetooth communication module, according to the wireless device list, the first device establishes the wireless communication 302 in turn with the peripheral wireless devices which support the first type of wireless communication through the first wireless communication module.

The first device sends the user-defined parameter set inquiry command 303 through the first wireless communication module to the peripheral wireless devices which support the first type of wireless communication. The second device could identify this inquiry command, and response to this inquiry command. Then the second device informs the first device of its stored parameter set 304 (including supported types of wireless communications, and wireless parameters related to various types of wireless communications, such as the MAC addresses of the first and the second type of wireless communications) through the first wireless communication module. The first device records the wireless parameters 305 of the peripheral wireless devices obtained through the first wireless communication module, including the wireless parameters of the second device. The first device forms the unique entity 306 of the second device according to the parameter set of the second device obtained through the first wireless communication module.

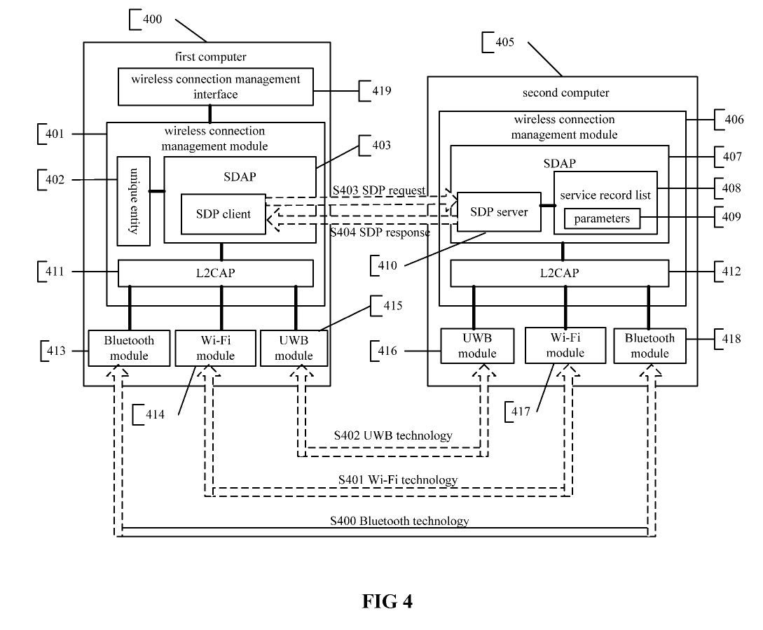

FIG. 4 is a structural block diagram illustrating the parameter inquiry and response through Bluetooth SDAP according to a preferable embodiment of this invention, wherein the first computer is a multi-wireless device provided with the wireless connection management module and the wireless connection management interface according to this invention. While the second computer could either be a multi-wireless device which supports various types of wireless communications, or a simple wireless device which only supports a single type of wireless communication. For the sake of simplification, the second computer is considered as a multi-wireless device.

As shown in FIG. 4, both the first computer 400 and second computer 405 support Bluetooth technology, Wi-Fi technology and UWB technology. They are respectively provided with Bluetooth module 413/418, Wi-Fi module 414/417, and UWB module 415/416.

The wireless connection management module 401 of the first computer 400 and the wireless manager 406 of the second computer 405 is respectively provided with Bluetooth SDAP 403 and 407. In this case, parameter inquiry and response between the second computer 405 and the first computer 400 through Bluetooth technology S400, Wi-Fi technology S401 and UWB technology S402 could be uniformly managed based on Bluetooth SDP request S403 and SDP response S404. The wireless manager 406 of the second computer 405 configures the parameters 409, including the types of wireless communications supported by the second computer (Bluetooth technology, Wi-Fi technology and UWB technology), the wireless parameters related to each type of wireless communication, such as MAC address (Bluetooth MAC address, Wi-Fi MAC address and network identification, and UWB MAC address), and the device name and the unique device identifier of each type of wireless communication supported by the second device, and etc. The configured parameter set 409 is stored in the service record list 408 of SDP 407. In this case, the first computer 400 acts as the SDP client 404, while the second computer acts as the SDP server 410. The first computer 400 sends the SDP request S403, and then the second computer 405 feeds back with the SDP response S404.

To coordinate the data transmission between the upper layer protocols of the wireless connection management module 401/406 and the lower layer protocols of Bluetooth module 413/418, Wi-Fi module 414/417, and UWB module 415/416, the wireless connection management module 401 and 406 are respectively provided with logical link adaptation layer 411 and 412.

After the first computer 400 establishes Bluetooth connection with the second computer 405, SDAP 403 sends the SDP request S403 to the second computer 405 through Bluetooth technology S400 to inquire parameters. When the wireless connection management module 406 of the second computer 405 receives this SDP request S406, SDAP 407 picks up the service record of the related parameter set 409 from the service record list 408, and then returns the SDP response S404 to the first computer 400. The wireless connection management module 401 of the first computer 400 records and stores the parameter set 409, and forms the parameter set of the unique entity 402 of the second computer 405. This parameter set includes the types of wireless communications supported by the second device: Bluetooth technology, Wi-Fi technology and UWB technology, and other parameters such as Bluetooth MAC address, Wi-Fi MAC address and network identification, and UWB MAC address, and etc. Correspondingly, the second computer 405 is displayed as a unique identification on the wireless connection management interface 419 (for instance icon, name, or etc.).

In this way, the user could select a certain wireless device on a uniform wireless connection management interface through the unique identification (for instance the icon), and process the operation of establishing or releasing the first type or the second type of wireless communication. The wireless connection management modules identifies the control command of each operation from the wireless connection management interface, and implements the operations by identifying the wireless parameters corresponding to the wireless device from the parameter set of the unique entity.

In this way, when the user controls and selects to establish Bluetooth communication S400, Wi-Fi communication S401, or UWB communication S402 with the second computer 405 through the unique identification on the wireless connection management interface 419 of the first computer 400, the wireless connection management module 401 identifies the control command from the wireless connection management interface 419, and then manages the Bluetooth communication with the second computer according to the Bluetooth MAC address in the unique entity 402 of the second computer 405, or manages the Wi-Fi communication with the second computer according to the Wi-Fi MAC address and network identification in the unique entity 402, or manages the UWB communication with the second computer according to the UWB MAC address in the unique entity 402.

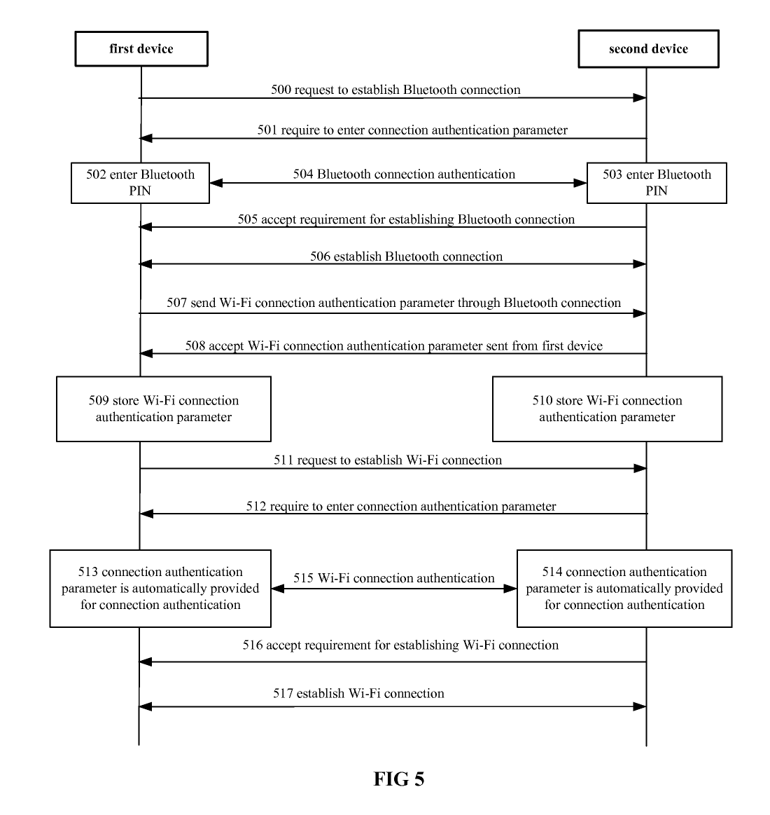

FIG. 5 is a message flow chart illustrating the steps of the automatic connection authentication between the multi-wireless device and another wireless device according to a preferable embodiment of this invention.

In this preferable embodiment, both the multi-wireless device (for instance the first device) and the other wireless device (for instance the second device) are simultaneously provided with Bluetooth module and Wi-Fi module. Both of them are Bluetooth/Wi-Fi multi-wireless devices. The first device requests to establish the Bluetooth connection 500 with the second device according the Bluetooth MAC address in the unique entity, while the second device asks the first device to provide the Bluetooth connection authentication parameter 501. The Bluetooth connection authentication parameter is usually a Bluetooth Personal Identification Number (PIN), thereby the Bluetooth PIN 502 is entered at the first device side, and the Bluetooth PIN 503 is entered at the second device side to proceed with the Bluetooth connection authentication. If the connection authentication is successful, the second device accepts the request of establishing the Bluetooth connection 505 from the first device. Thus the Bluetooth connection 506 between the first device and the second device is successfully established.

Afterwards, the first device consults with the second device about the Wi-Fi connection authentication parameter between the first device and the second device through the established Bluetooth connection including the Wi-Fi connection authentication parameter 507 sent from the first device to the second device (it could include the parameters such as network identification, WEP password or WAP password, encryption algorithm, and etc.). The consultation succeeds if the second device accepts the Wi-Fi connection authentication parameter 508 sent from the first device. If the second device rejects the Wi-Fi connection authentication parameter sent from the first device, the first device and the second device needs to further consult with each other about the Wi-Fi connection authentication parameter. For instance, the second device keeps on sending the Wi-Fi connection authentication parameter to the first device, while the first device could choose to accept or reject the Wi-Fi connection authentication parameter sent by second device, until both of the two devices agree on a same Wi-Fi connection authentication parameter. The first device stores the agreed Wi-Fi connection authentication parameter 509, for instance, it is stored into the parameter set of the unique entity corresponding to the second device as a parameter. While the second device also stores the agreed Wi-Fi connection authentication parameter 510, for instance, it is added to the configured parameter.

When the first device requests to establish the Wi-Fi connection 511 with the second device, the second device asks the first device to provide the connection authentication parameter 512. The first device identifies the Wi-Fi MAC address of the second device, and finds the Wi-Fi connection authentication parameter, which is used for the Wi-Fi connection authentication 513 between the first device and the second device, with the second device from the parameter set of the unique entity according to the Wi-Fi MAC address of the second device. Meanwhile, the second device also finds the Wi-Fi connection authentication parameter, which is used for the Wi-Fi connection authentication 514 between the first device and the second device, with the second device from the parameter set of the unique entity according to the Wi-Fi MAC address of the second device. Then the first device and the second device proceed with the connection authentication 515. If the connection authentication is successful, the second device accepts the request of establishing the Wi-Fi connection 516 from the first device. Thus the Wi-Fi connection 517 between the first device and the second device is successfully established.

Although the present invention is illustrated and described with reference to its preferable embodiments, those ordinarily skilled in the art shall understand that various changes in form and detail are allowable in the case of not deviating from spirit and scope of the invention defined in the appended Claims.

What we claim is:

1. A method applied for a multi-wireless device to manage multiple types of wireless radios of short distance wireless communication, said multi-wireless device consists of multiple wireless communication modules to support multiple types of short distance wireless communications with said at least one other wireless device, said method comprising steps of:
for each wireless device among said other wireless devices which communicate with the multi-wireless, the multi-wireless device respectively obtains the wireless parameters of the wireless device through associated wireless communication module of said multiple wireless communication modules;
for each wireless device, a parameter set of a unique entity is formed in the multi-wireless device to record all the wireless parameters of the wireless device based on the obtained wireless parameters; and
for each parameter set of the unique entity, an associated unique entity identification is displayed on the wireless connection management interface of the multi-wireless device, so that a user could uniformly operate and manage the short distance wireless communication between the multi-wireless device and the wireless device corresponding to the parameter set of the unique entity.

2. The management method according to claim 1, characterized in that the wireless parameters of said wireless device includes the types of short distance wireless communication supported by the wireless device, the MAC address related to each type of short distance wireless communication;
said short distance wireless communication includes at least Bluetooth communication, Wi-Fi communication, and UWB communication;
and when said short distance wireless communication is Wi-Fi communication, the wireless parameters of said parameter set of the unique entity further includes the network identification.

3. The management method according to claim 1, characterized in that said obtaining the wireless parameters includes steps of:
(a) through each wireless communication module, the multi-wireless device respectively obtains the list of peripheral wireless devices which support associated types of short distance wireless communications;
(b) through each wireless communication module, the multi-wireless device respectively establishes wireless communication in turn with associated wireless device in the wireless device list;
(c) the multi-wireless device sends the parameter inquiry commands to the connected wireless devices, and receives and stores the wireless parameters coming from the wireless devices.

4. The management method according to claim 1, characterized in that forming a parameter set of a unique entity, the obtained wireless parameters includes the unique device identifier for uniquely identifying the wireless device, said step including:
the multi-wireless device compares all the unique device identifiers respectively obtained through each wireless communication module, and merges the wireless parameters of the wireless device corresponding to the identical unique device identifier, and records them in a parameter set of a unique entity.

5. The method according to claim 4, said unique device identifier is configured with the Global Unique Identifier (GUID).

6. The method according to claim 4, characterized in that when said other wireless devices support multiple types of short distance wireless communications, and for each device among said other wireless devices, when the device names respectively related to each type of short distance wireless communication are configured with a unique device name, said unique device identifier could be configured with the unique device name.

7. The method according to claim 4, characterized in that when said other wireless devices support multiple types of short distance wireless communications, and for each device among said other wireless devices, when the MAC addresses respectively related to each type of short distance wireless communication are identical, said unique device identifier could be configured with the MAC address.

8. The method according to claim 3, characterized in that before step (c), there is another step that the multi-wireless device sends the user-defined parameter set inquiry command, so that the multi-wireless device could obtain the parameter sets of various wireless parameters related to the types of wireless communications supported by the wireless devices from the wireless devices which support multiple types of wireless communications.

9. The method according to claim 8, characterized in that a wireless device among said other wireless devices could enumerate and configure all wireless parameters related to all types of short distance communications supported by itself, and includes the parameters in the parameter set. Moreover, after receiving the parameter set inquiry command from the multi-wireless device, the wireless device informs the multi-wireless device of all parameters included in the parameter set.

10. The method according to claim 3, characterized in that both the multi-wireless device and the wireless device are provided with Bluetooth Profile Service Discovery Application Profile (SDAP), and all the parameters related to wireless communication of the wireless device are stored and registered in the SDAP service record list, said sending step including:
the multi-wireless device sends the parameter inquiry command through SDAP sending Service Discovery Protocol (SDP) request, and
the wireless device feeds back with SDP response through SDAP after receiving the SDP request, in order to inform the multi-wireless device of all its parameters.

11. The management method according to claim 1, characterized in that the multi-wireless device consults with the one of other wireless devices through the first type of wireless communication among multiple wireless communication modules about the connection authentication parameter required by the second type of wireless communication between the multi-wireless device and the one of other wireless devices, in order that the automatic connection authentication could proceed when the second type of communication is established.

12. The method according to claim 11, characterized in that said authentication parameter includes the secret key and the configuration and selection of encryption algorithm;
and both the multi-wireless device and the one of other wireless devices store the agreed connection authentication parameter required by the second type of wireless communication, and the multi-wireless device records this connection authentication parameter in the parameter set of the unique entity of the one of other devices.

13. A multi-wireless device that is able to manage multiple types of short distance wireless communications, including:
multiple wireless communication modules, used for supporting multiple types of short distance wireless communications with the at least one other wireless device;
a wireless connection management modules connected to the multiple wireless communication modules. The wireless connection management module is configured that for each wireless device of the other wireless devices communicating with the multi-wireless device, a parameter set of a unique entity is formed in the multi-wireless device based on the obtained wireless parameters, in order to record all wireless parameters of the wireless device; and
a wireless connection management interface connected to the wireless connection management module. The wireless connection management interface is configured that for each parameter set of the unique entity, an associated unique entity identification is displayed, so that the user could uniformly operate and manage the short distance wireless communication between the multi-wireless device and the wireless device corresponding to the parameter set of the unique entity.

14. The first device according to claim 13, characterized in that said wireless parameters include the types of short distance wireless communications supported by the wireless device, and the MAC addresses related to each type of short distance wireless communication;
said short distance wireless communication includes at least Bluetooth technology, Wi-Fi technology, and UWB technology;
and when the short distance wireless communication is Wi-Fi technology, said parameter set of unique entity further includes the network identification.

15. The multi-wireless device according to claim 13, characterized in that said wireless connection management module is configured that:
lists of the wireless devices supporting associated wireless communications are respectively obtained through each wireless communication module; the multi-wireless device communicates respectively with the devices from said wireless device lists through each wireless communication module, and sends the parameter inquiry command to the wireless device and receives and stores the wireless parameters from the wireless device.

16. The multi-wireless device according to claim 13, the obtained wireless parameters includes a unique device identifier used for uniquely identifying the wireless device, and
said wireless connection management module is further configured that: all the unique device identifiers obtained through each wireless communication module are compared, and the wireless parameters of the wireless devices corresponding to the identical unique device identifiers are merged and recorded in a parameter set of a unique entity.

17. The multi-wireless device according to claim 16, wherein said wireless connection management module could configure the unique device identifier with the Global Unique Identifier (GUID).

18. The multi-wireless device according to claim 16, characterized in that when said other wireless devices support multiple types of short distance wireless communication, and for each wireless device among the other wireless devices, when the device names respectively related to each type of short distance wireless communication are all configured with the unique device name, the wireless connection management module could configure the unique device identifier with the unique device name.

19. The multi-wireless device according to claim 16, characterized in that when said other wireless devices support multiple types of short distance wireless communication, and for each wireless device among the other wireless devices, when the MAC addresses respectively related to each type of short distance wireless communication are identical, the wireless connection management module could configure the unique device identifier with the MAC address.

20. The multi-wireless device according to claim 15, characterized in that said wireless connection management module is further configured that:
the user-defined parameter set inquiry command is sent to the wireless devices in said wireless device lists, so that the parameter set of all wireless parameters related to the types of wireless communications supported by the multi-wireless device is obtained from the wireless devices which support multiple types of wireless communications.

21. The multi-wireless device according to claim 15, characterized in that said wireless connection management module further includes Bluetooth Profile Service Discovery Application Profile (SDAP), and said wireless connection management module is configured that the multi-wireless device sends the parameter inquiry command through SDAP sending Service Discovery Protocol (SDP) request.

22. A system that is able to manage multiple types of short distance wireless communications, including a multi-wireless device according to claim 13-21, and at least one other device which communicates with said multi-wireless device in multiple short distance wireless communication ways.

23. The system according to claim 22, wherein a wireless device among said other wireless devices is provided with a wireless manager, which is able to enumerate and configure all wireless parameters related to all types of short distance communications supported by itself, and includes the parameters in the parameter set. Moreover, after receiving the parameter set inquiry command from said multi-wireless device, the wireless device informs the wireless connection management module of all wireless parameters included in the parameter set.

24. The multi-wireless device according to claim 22, characterized in that the wireless device includes Bluetooth Profile Service Discovery Application Profile (SDAP), and all the parameters related to wireless communication of the wireless device are stored and registered in the SDAP service record list, and when the multi-wireless device sends the parameter inquiry command through SDAP sending Service Discovery Protocol (SDP) request, the wireless device feeds back with SDP response through SDAP in order to inform the multi-wireless device of the wireless parameters of associated type of wireless communication.
